(19) United States
(12) Patent Application Publication
(10) Pub. No.: US 2026/0205428 A1
(43) Pub. Date: Jul. 16, 2026

(54) ELECTRONIC DEVICE AND METHOD FOR MANAGING A CALL SESSION BETWEEN A PLURALITY OF DEVICES

(71) Applicant: Samsung Electronics Co., Ltd., Suwon-si (KR)

(72) Inventors: Prasenjit CHAKRABORTY, Bangalore (IN); Naveen KOLATI, Bangalore (IN); Abhishek SONI, Bangalore (IN); Ravi SURANA, Bangalore (IN); Rohit PANDEY, Bangalore (IN); Aranya SAMAIYAR, Bangalore (IN); Akshobhya, Bangalore (IN); Siva Prasad GUNDUR, Bangalore (IN)

(21) Appl. No.: 19/255,187

(22) Filed: Jun. 30, 2025

Related U.S. Application Data
(63) Continuation of application No. PCT/KR2025/005920, filed on Apr. 30, 2025.

(30) Foreign Application Priority Data
Jan. 15, 2025 (IN) 202541003387

(51) Int. Cl. H04L 51/02; H04L 65/1046

(52) U.S. Cl. CPC H04L 51/02; H04L 65/1046

(57) ABSTRACT

A method and a system for managing a call session between a plurality of devices is disclosed. The method comprises transmitting electronic device information associated with the electronic device and Artificial Intelligence (AI) model information corresponding to one or more AI models supported by the electronic device in a call session to one or more candidate devices among the plurality of devices; receiving at least one of a candidate device information associated with the one or more candidate devices or candidate AI model information corresponding to the one or more AI models; selecting a device among the one or more candidate devices for executing the one or more AI models; and transmitting a command to activate the one or more AI models for execution to the selected device for a predefined period.

### CROSS-REFERENCE TO RELATED APPLICATIONS

This application is a continuation of International Application No. PCT/KR2025/005920 designating the United States, filed on Apr. 30, 2025, in the Korean Intellectual Property Receiving Office, and claiming priority to Indian Patent Application No. 202541003387, filed on Jan. 15, 2025, in the Indian Patent Office, the disclosures of each of which are incorporated by reference herein in their entireties.

### BACKGROUND

### Field

The disclosure relates to wireless communication, and for example, relates to a system and a method for managing a call session between a plurality of devices.

### Description of Related Art

Split computation and computational offloading are well-established concepts in the field of Artificial Intelligence (AI). The existing techniques in this domain focus on sharing targeted AI models across nearby or cloud devices, either entirely or partially, using known methods to achieve performance gains. While these methods have proven effective in enhancing computational capabilities, such methods do not adequately address critical challenges such as environmental sustainability or user experience, especially in the context of modern computational demands.

Efficient computation has become increasingly important for AI applications aimed at enhancing user experiences. However, executing AI models on devices presents several challenges. For example, in applications such as speech translation, both devices involved in a call are often capable of running AI models, but typically only one device is selected to execute the model. This leads to issues, particularly when the selected device is less capable, such as rapid battery depletion, overheating, or even device crashes. Furthermore, sharing sensitive device information, such as battery status, Random Access Memory (RAM), or AI model details, with untrusted users poses significant privacy risks. Existing techniques lack secure mechanisms to reliably identify trusted users or safely share such information, which exacerbates privacy concerns.

Another significant limitation of current methods is the rigidity in device selection for AI model execution. Device selection typically occurs at the initial stage and does not adapt to changes in device conditions during execution. For instance, a device selected to run the AI model might experience battery depletion or overheating, while another device could be more suited to handle the workload at that moment. This lack of dynamic reassignment of the task results in suboptimal performance and a degraded user experience. In particular, when AI models are executed on inferior (less capable) devices, they can lead to rapid battery drain, overheating, and system instability, such as crashes or freezes. On the other hand, superior (more capable) devices, equipped with dedicated Neural Processing Units (NPUs), can execute the same models more efficiently, leading to slower battery drain, minimal overheating, and better system stability.

Despite the advancements in AI computation, current techniques lack the flexibility to adjust the execution of AI models between devices based on real-time conditions, thus leading to poor user experiences, especially on less capable devices.

The environmental impact of computational inefficiencies is another critical concern. Over the past decade, the rechargeable lithium-ion battery market has doubled on average every three years. Batteries are central to the global shift toward energy de-carbonization and mitigating climate change. However, the battery value chain faces significant challenges, including unsafe raw material extraction, high greenhouse gas emissions during production, and limited deployment in low-income regions. Optimizing power consumption in electronic devices can play a crucial role in reducing their carbon footprint and promoting sustainability.

Sustainability in mobile devices requires minimizing and/or reducing environmental impact, conserving resources, and enhancing energy efficiency. Effective management of energy consumption can be achieved through optimizing battery use, extending battery lifespan, reducing e-waste, and exploring renewable energy sources for charging. By adopting these practices, the environmental footprint of mobile technology can be significantly reduced, contributing to a healthier planet. Addressing these challenges through improved AI computation methods and sustainable practices can lead to better user experiences and a more sustainable future.

Hence, there is a need to provide improved techniques that address the above-mentioned and other related problems.

### SUMMARY

According to an example embodiment, a method for managing a call session between a plurality of devices is disclosed. The method comprises: transmitting, by an electronic device among the plurality of devices, electronic device information associated with the electronic device and Artificial Intelligence (AI) model information corresponding to one or more AI models supported by the electronic device in the call session, the electronic device information and the AI model information being transmitted to one or more candidate devices among the plurality of devices; receiving, by the electronic device, at least one of a candidate device information associated with the one or more candidate devices or candidate AI model information corresponding to the one or more AI models, from the one or more candidate devices; selecting, by the electronic device, a device among the one or more candidate devices for executing the one or more AI models based on at least one of the electronic device information, the candidate device information, the AI information, or the candidate AI model information; and transmitting, by the electronic device, a command to activate the one or more AI models for execution to the selected device for a predefined period.

According to an example embodiment, an electronic device for managing a call session between a plurality of devices is disclosed. The electronic device comprises: at least one processor comprising processing circuitry. The electronic device comprises memory comprising one or more storage mediums storing one or more instructions. When executed by the at least one processor individually or collectively, may cause the electronic device to: transmit electronic device information associated with the electronic device and Artificial Intelligence (AI) model information, the AI model information corresponding to one or more AI models supported by the electronic device in a call session, wherein the electronic device information and the AI model information are transmitted to one or more candidate devices among the plurality of devices; receive at least one of a candidate device information associated with the one or more candidate devices or candidate AI model information corresponding to the one or more AI models, from the one or more candidate devices; select a device among the one or more candidate devices for executing the one or more AI models based on at least one of the electronic device information, the candidate device information, the AI information, or the candidate AI model information; and transmit a command to activate the one or more AI models for execution to the selected device for a predefined period.

A detailed description of the disclosure will be rendered by reference to various example embodiments thereof, which is illustrated in the appended drawings. It will be appreciated that these drawings depict example embodiments and are therefore not to be considered limiting its scope. The disclosure will be described and explained with additional specificity and detail with the accompanying drawings.

### BRIEF DESCRIPTION OF THE DRAWINGS

The foregoing and other aspects, features and advantages of certain embodiments of the present disclosure will be more apparent from the following detailed description, taken in conjunction with the accompanying drawings, in which like reference numerals refer to like elements.

FIG. 1 is a diagram illustrating an example environment for managing a call session between a plurality of devices, according to various embodiments;

FIG. 2 is a block diagram illustrating an example configuration of a system for managing the call session between the plurality of devices according to various embodiments;

FIG. 3 is a flowchart illustrating an example method for managing the call session between the plurality of devices, according to various embodiments;

FIG. 4 is a signal flow diagram illustrating example exchange of device and Artificial Intelligence (AI) model information, according to various embodiments;

FIG. 5A and 5B are signal flow diagrams illustrating example selection of a candidate device, according to various embodiments;

FIG. 6 is a signal flow diagram illustrating an example of managing the call session between the plurality of devices, according to various embodiments;

FIGS. 7A and 7B are signal flow diagrams illustrating managing the call session between the plurality of devices, according to various embodiments; and

FIGS. 8A and 8B illustrate managing the call session between the plurality of devices, according to various embodiments.

### DETAILED DESCRIPTION

Reference will now be made to the various example embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in an embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Hereinafter, it is understood that terms including “unit” or “module” at the end may refer to the unit for processing at least one function or operation and may be implemented in hardware, software, or a combination of hardware and software.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” may refer to any device, system, or part thereof that controls at least one operation. The functionality associated with any particular controller may be centralized or distributed, whether locally or remotely. The phrase “at least one of,” when used with a list of items, may refer, for example, to different combinations of at least one of the listed items being used, and only one item in the list may be needed. For example, “at least one of A, B, and C” includes any of the following combinations: only A, only B, only C, both A and B, both A and C, both B and C, all of A, B and C, or any variations thereof. As an additional example, the expression “at least one of a, b, or c” may indicate only a, only b, only c, both a and b, both a and c, both b and c, all of a, b, and c, or any variations thereof. Similarly, the term “set” may refer, for example, to one or more. Accordingly, the set of items may be a single item or a collection of two or more items.

Unless otherwise defined, all terms, and especially any technical and/or scientific terms, used herein may be taken to have the same meaning as commonly understood by one having ordinary skill in the art.

The various example embodiments herein and the various features and advantageous details thereof are explained more fully with reference to the non-limiting embodiments that are illustrated in the accompanying drawings and detailed in the following description. Descriptions of well-known components and processing techniques may be omitted to not unnecessarily obscure the various embodiments herein. The various embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the various embodiments herein can be practiced and to further enable those skilled in the art to practice the various embodiments herein. Accordingly, the examples should not be construed as limiting the scope of the various embodiments herein.

Various embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

The accompanying drawings are used to help understand various technical features and it should be understood that the various embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

In this disclosure, unless specifically stated otherwise, the use of the singular includes the plural, and the use of “or” includes “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

The present disclosure discloses techniques to enhance the execution of Artificial Intelligence (AI) models on electronic devices by leveraging collaborative device management. The disclosed techniques enable the secure sharing and negotiation of AI model features, device capabilities, and status information among trusted users. In an embodiment, the disclosed techniques enhance real-time user experience and sustainability by periodically exchanging device conditions, capabilities, and AI model information between devices during a call. Further, the disclosed techniques introduce a dynamic switching mechanism to transfer AI model execution between devices as conditions change, ensuring sustained performance and energy efficiency.

Embodiments of the present disclosure will be described below in greater detail with reference to the accompanying drawings.

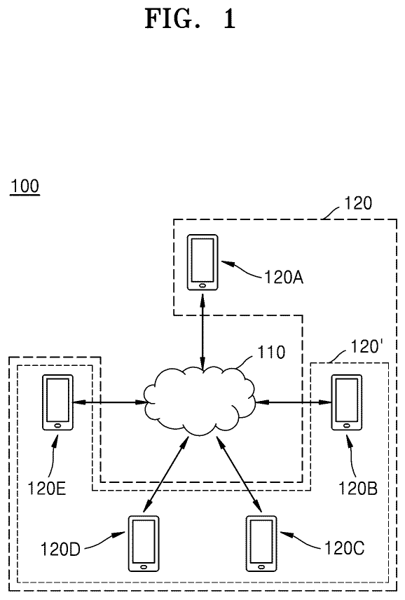

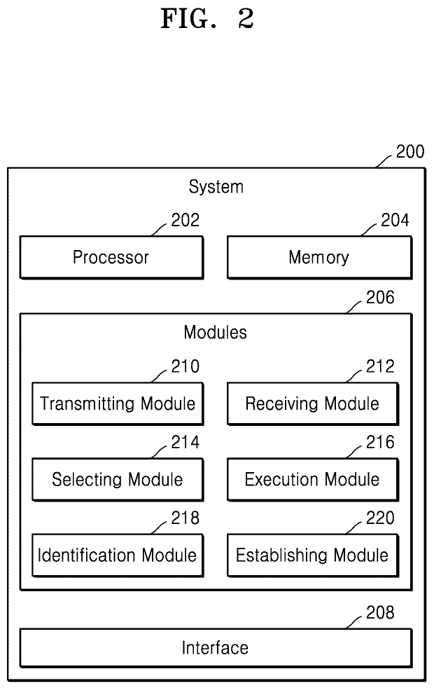

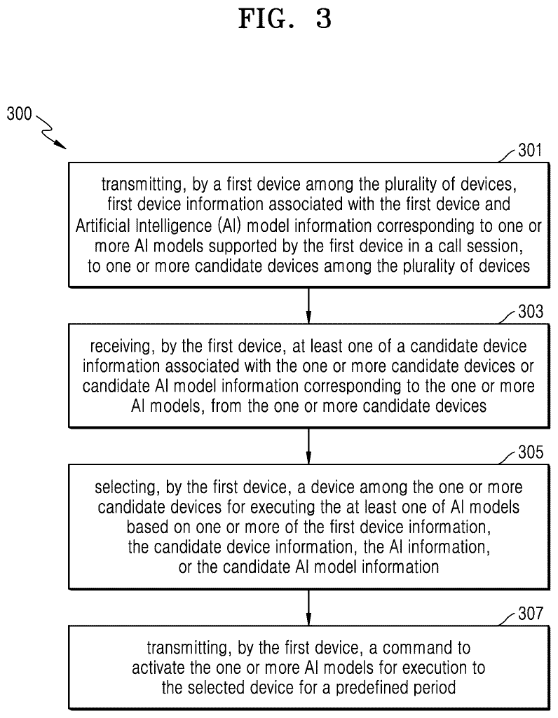

FIG. 1 is a diagram illustrating an example environment 100 for managing a call session between a plurality of devices, according to various embodiments. FIG. 2 is a block diagram illustrating an example configuration of a system 200 for managing the call session between the plurality of devices, according to various embodiments. FIG. 3 is a flowchart illustrating an example method 300 for managing the call session between the plurality of devices, according to various embodiments. For the sake of brevity, the description of FIGS. 1, 2, and 3 are explained in conjunction with each other.

Referring to FIG. 1, as shown, the environment 100 may include a plurality of devices 120A, 120B, 120C, 120D, and 120E (herein referred to as the plurality of devices 120). In an embodiment, a “device” may also be referred to as an “electronic device”. The plurality of devices 120 may communicate with each other via a wireless communication network 110. In some examples, the wireless communication network 100 may be a Long Term Evolution (LTE) network, an LTE-Advanced (LTE-A) network, an LTE-A Pro network, a New Radio (NR) network, a Fifth-Generation (5G) network, a Sixth-Generation (6G) network, a 6G-pro network or similar networks. In some examples, the wireless communication network 110 may support enhanced broadband communications, ultra-reliable (e.g., mission-critical) communications, low latency communications, communications with low-cost and low-complexity devices, or any combination thereof. However, it will be understood that the disclosure is not limited thereto.

Further, each of the plurality of devices 120 may be capable of executing AI models. Each of the plurality of devices 120 may include or may be referred to as a mobile device, a wireless device, a remote device, a handheld device, a subscriber device, or some other suitable terminology, where the “device” may also be referred to as a unit, a station, a terminal, or a client, among other examples. Each of the plurality of devices 120 may also include or may be referred to as a personal electronic device, such as a cellular phone, a personal digital assistant (PDA), a tablet computer, a laptop computer, or a personal computer. In some examples, each of the plurality of devices 120 may include or be referred to as a wireless local loop (WLL) station, an Internet of Things (IoT) device, an Internet of Everything (IoE) device, or a machine-type communications (MTC) device, among other examples, which may be implemented in various objects such as appliances, or vehicles, meters, among other examples.

Referring to FIG. 2, the system 200 may include but is not limited to, at least one processor (e.g., including processing circuitry) 202 (herein referred to as a processor), memory 204 (e.g., including one or more storage mediums), modules (e.g., including various circuitry and/or executable program instructions) 206, and an interface (e.g., including circuitry) 208. The memory 204, the modules 206, and the interface 208 may be coupled to the processor 202. In an embodiment, the system 200 may be a part of at least one of the plurality of devices 120, such as a first device 120A. For example, the first device 120A may be an electronic device comprise at least a part of the system 200.

The processor 202 may include various processing circuitry and can be a single processing unit or several units, all of which could include multiple computing units. The processor 202 may be implemented as one or more microprocessors, microcomputers, microcontrollers, digital signal processors, central processing units, state machines, logic circuitries, and/or any device that manipulates signals based on operational instructions. Among other capabilities, the processor 202 is configured to fetch and execute computer-readable instructions and data stored in the memory 204. In an embodiment, at least one processor included in the system 200 may execute one or more instructions stored in the memory 204 individually or collectively. When executed by at least one processor individually or collectively, the one or more instructions may cause the system 200 to perform any combination of methods, steps, and/or functions described herein. Each “processor” (e.g., processor 202) or “model” herein includes processing circuitry, and/or may include multiple processors. For example, as used herein, including the claims, the term “processor” or “model” may include various processing circuitry, including at least one processor, wherein at least one of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The memory 204 may include one or more storage mediums. For example, the memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 204 may include an operating system for performing one or more tasks of the system 200, as performed by a generic operating system in the communications domain. In an embodiment, the memory 204 may store the AI models for execution on the corresponding device among the plurality of devices 120. In an embodiment, a non-transitory computer-readable storage medium may store one or more instructions. The one or more instructions may, when executed by at least one processor of an electronic device individually or collectively, cause the electronic device to perform any combination of methods, operations, and/or functions in accordance with the present disclosure.

The modules 206 may, amongst other things, include various circuitry and/or routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 may be implemented in hardware, instructions executed by a processing unit, or by a combination thereof. The processing unit can comprise a computer, a processor, such as the processor 202, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In an embodiment of the present disclosure, the modules 206 may be machine-readable instructions (software) which, when executed by a processor/processing unit, perform any of the described functionalities.

In various embodiments, the modules 206 may include a set of instructions that may be executed to cause the system 200 to perform any one or more of the methods disclosed herein. The modules 206 may be configured to perform the steps of the present disclosure using the data stored in the memory 204 to manage the call session between the plurality of devices 120, as discussed throughout this disclosure. In an embodiment, each of the modules 206 may be hardware units that may be outside the memory 204.

In an embodiment, the modules 206 may include a transmitting module 210, a receiving module 212, a selecting module 214, an execution module 216, an identification module 218, and an establishing module 220. The modules 206 and their working is further explained in detail in the following paragraphs.

The various modules 210-220 may be in communication with each other. In an embodiment, the various modules 210-220 may be a part of the processor 202. In an embodiment, the processor 202 may be configured to perform the functions of modules 210-220.

At least one of the modules 210-220 may be implemented through an artificial intelligence (AI) model. A function associated with AI may be performed through the non-volatile memory, the volatile memory, and the processor 202. Accordingly, the processor 202 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Each of the above “processing units” may include a processor as described above with reference to the processor 202. The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include a plurality of neural network layers. Each layer may have a plurality of weight values and performs a layer operation through calculation of a previous layer and an operation of a plurality of weights. Examples of neural networks include but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), deep Q-networks, or the like.

The learning technique may refer, for example, to a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, a method for managing the call session between the plurality of devices 120 may use an artificial intelligence model to recommend/execute the plurality of instructions using sensor data. The processor may perform a pre-processing operation on the data to convert it into a form appropriate for use as an input for the artificial intelligence model. The artificial intelligence model may be obtained by training. Here, “obtained by training” may refer, for example, to a predefined operation rule or artificial intelligence model configured to perform a desired feature (or purpose) being obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction may refer to a technique of logically reasoning and predicting by determining information and includes, e.g., knowledge-based reasoning, optimization prediction, preference-based planning, or recommendation.

The interface 208 may include various circuitry and may be configured to provide network connectivity and enable communication with paired devices such as the system 200. The network connectivity may be provided via a wireless connection or a wired connection. For example, the network connectivity may be provided via cellular technology, such as Third-Generation (2G), 4G, 5G, pre-5G, 6G, or any other wireless communication technology such as Bluetooth.

In an example embodiment, a first device 120A among the plurality of devices 120 is in communication with one or more candidate devices 120B, 120C, and 120D (also referred to as one or more candidate devices 120′). The first device 120A and at least one of the one or more candidate devices 120′ are capable of executing AI models, such as a language translation model. The first device 120A and the one or more candidate devices 120′ may be connected to the wireless communication network 110. Further, the first device 120A and the one or more candidate devices 120′ may be connected via any one of a voice call, a video call, an Extended Reality (XR) environment, an Augmented Reality (AR) environment, a Virtual Reality (VR) environment to exchange any one of an audio, a video, a text, a haptic content, a sensor content or any other media content. In an embodiment, the method discussed in connection with FIG. 3 has been explained in reference to the above discussed example embodiment.

Referring now to FIG. 3, as shown in FIG. 3, at operation 301, the method 300 may include transmitting the first device information associated with the first device 120A and AI model information. The AI model information may correspond to one or more AI models supported by the first device 120A in a call session, such as the language translation model. The call session may refer to a call between the first device 120A and the one or more candidate devices 120′. In particular, the transmitting module 210 may transmit the first device information and the AI model information to the one or more candidate devices 120′. However, prior to transmitting the first device information and the AI model information, the first device 120A may establish a collaboration call with the one or more candidate devices 120′. For example, the transmitting module 210 may transmit a collaboration call request to the one or more candidate devices 120′. In a non-limited embodiment, the transmitting module 210 may transmit the collaboration call request to the one or more candidate devices 120′ in a Session Initiation Protocol (SIP) message. In response, the receiving module 212 may receive candidate device capabilities associated with each of the one or more candidate devices 120′. In a non-limited embodiment, the receiving module 212 may receive the candidate device capabilities from the one or more candidate devices 120′ in an SIP message. In an example embodiment, the candidate device capabilities may indicate the device capabilities to establish the collaboration call, such as having adequate ROM space to receive the AI model or sufficient battery power to run the AI model. Accordingly, if the collaboration call is an AI collaboration call, the candidate device capabilities may indicate whether the corresponding candidate device is capable of the AI collaboration call or not. After receiving the candidate device capabilities, the establishing module 220 may establish the collaboration call with the one or more candidate devices 120′ based on the received candidate device capabilities.

Further, prior to transmitting the first device information and the AI model information, the identification module 218 may identify the one or more candidate devices 120′ from a list of trusted devices. For example, a user of the first device 120A may prepare a list of trusted devices with which the user wants to share important information associated with the first device 120A in a secure way. In an example embodiment, the user may create different groups for the trusted devices. For example, the user may only add favorite contacts to the list of trusted devices. In another example, the user may add all the contacts to the list of trusted devices. In yet another example, the user may create a group of friends and family members and add that group to the list of trusted devices. In another example, the user may add devices within a predefined ecosystem to the list of trusted devices. Further, the user may use a User Interface (UI) to create/add/modify the list of trusted devices. Accordingly, a UI feature may be implemented to allow users to choose whether they want to have collaborative calls for an enhanced user experience. Accordingly, the identification module 218 may identify the one or more candidate devices 120′ from the list of trusted devices. Accordingly, the transmitting module 210 may transmit the first device information and the AI model information to the one or more candidate devices 120′.

Further, in an embodiment, the first device information may include but is not limited to, the size of a Random Access Memory (RAM), the size of a Read Only Memory (ROM), a display size, processing information associated with at least one of a Central Processing Unit (CPU), a Graphics Processing Unit (GPU), and a Neural Processing Unit (NPU), or a battery status of the first device 120A.

In an embodiment, the AI model information may include but is not limited to, at least one of the AI model name, the AI model version, an input parameter, an output, an AI model layer, or architecture details corresponding to each of the one or more AI models.

In an embodiment, the transmitting module 210 may transmit the first device information and the AI model information in a periodic manner. In an embodiment, the transmitting module 210 may transmit the first device information and the AI model information in response to an information request received from the one or more candidate devices 120′.

In a non-limiting embodiment, the transmitting module 210 may transmit the first device information and the AI model information in a Real-Time Transport Control Protocol (RTCP) Source Description (SDES) message.

Referring again to FIG. 3, at operation 303, the method 300 may include receiving at least one of a candidate device information associated with the one or more candidate devices 120′ or candidate AI model information, from the one or more candidate devices 120′. The candidate AI model information may correspond to the one or more AI models supported by the first device 120A. In an embodiment, the one or more AI models, such as the language translation module may not be available on the one or more candidate devices 120′. In such a scenario, the receiving module 212 may receive only the candidate device information, not the candidate AI model information. In response, the transmitting module 210 may transmit the one or more AI models to the one or more candidate devices 120′. Once the one or more candidate devices 120′ receive the one or more AI models, the one or more candidate devices 120′ may transmit the candidate AI model information. Accordingly, the receiving module 212 may receive the candidate AI model information in response to the transmitted one or more AI models.

Further, in an embodiment, the candidate device information may include but is not limited to, the size of a RAM, the size of a ROM, a display size, processing information associated with at least one of a CPU, a GPU, and a NPU, and a battery status of the one or more candidate devices 120′.

In an embodiment, the candidate AI model information may include but is not limited to, at least one of the AI model name, the AI model version, an input parameter, an output, an AI model layer, or architecture details corresponding to each of the one or more AI models.

In an embodiment, the receiving module 212 may receive the candidate device information and the candidate AI model information in a periodic manner. In an embodiment, the receiving module 212 may receive the candidate device information and the candidate AI model information in response to an information request transmitted from the first device 120A.

In a non-limiting embodiment, the receiving module 212 may receive the candidate device information and the candidate AI model information in an RTCP SDES message.

Referring again to FIG. 3, at operation 305, the method 300 may include selecting a candidate device among the one or more candidate devices 120′ for executing the one or more AI models. In an embodiment, the selecting module 214 may select the candidate device based on at least one of the first device information, the candidate device information, the AI information, or the candidate AI model information. For example, the candidate device 120B may have a faster NPU than the first device 120A and a maximum battery capacity among the one or more candidate devices 120′ and the first device 120A. Accordingly, the selecting module 214 may select the candidate device 120B for executing the one or more AI models. Accordingly, the first device 120A may evaluate all the candidate device information like ROM/NPU/Battery/RAM and then take a priority order to decide which is best device to execute the one or more AI models.

At operation 307, the method 300 may include transmitting a command to activate the one or more AI models for execution to the selected candidate device for a predefined period. For example, the transmitting module 210 may transmit the command to activate the one or more AI models on the selected candidate device such as 120B for the predefined period, such as 5 minutes or duration of the call session. In an embodiment, the predefined period may be pre-configured or user-defined. Further, in an embodiment, the transmitting module 210 may encrypt the one or more AI models using a predefined encryption technique. The transmitting module 210 may then transmit the encrypted one or more AI models to the selected candidate device 120B. In an embodiment, the transmitting module 210 may encrypt the electronic device information and the AI model information using a predefined encryption technique. The transmitting module 210 may then transmit the encrypted electronic device information and encrypted the AI model information to the one or more candidate devices.

Further, in an embodiment, the method 300 may include stopping execution of the one or more AI models on the first device 120A. In particular, the execution module 216 may stop the execution of the one or more AI models on the first device 120A after transmission of the activation command to the selected candidate device 120B. Accordingly, the execution of the one or more AI models is transferred to the selected candidate device 120B.

In an embodiment, the execution of the one or more AI models may be transferred during the call session also. For example, once the execution of the one or more AI models is transferred to the selected candidate device 120B, the selected candidate device 120B acts as the first device 120A. Accordingly, the selected candidate device 120B may perform the method 300 during the call session. Accordingly, the selected candidate device 120B may transfer the execution of the one or more AI models to any one of the plurality of devices 120. In such a scenario, steps 301-305 may be performed again to transfer the execution of the one or more AI models to any one of the plurality of devices 120.

In an embodiment, the receiving module 212 may receive a candidate device status associated with each of the one or more candidate devices 120′ over a predefined time interval till the end of the call session. Then, the transmitting module 210 may determine whether to transmit the command to activate the one or more AI models to one of the one or more candidate devices 120′ other than the selected candidate device 120B. The transmitting module 210 may make the said determination based on a first device status associated with the first device 120A and the candidate device status. In an embodiment, the first device status may include but is not limited to, a RAM load, a CPU load, an available ROM memory, a battery status, and a drain rate of the battery of the first device 120A. Similarly, the candidate device status may include but is not limited to, a RAM load, a CPU load, an available ROM memory, a battery status, and a drain rate of the battery of the one or more candidate devices 120′. Further, the predefined time interval may be pre-configured or user-defined, such as 20 seconds. Accordingly, in an example, if the battery status of the selected candidate device 120B indicates that the battery level of the selected candidate device 120B is low, then the transmitting module 210 may transmit the command to activate the one or more AI models to other candidate device 120D that has a higher battery level. In an embodiment, the command to activate the one or more AI models may include an inference stage of the one or more AI models to ensure a smooth transfer of the one or more AI models.

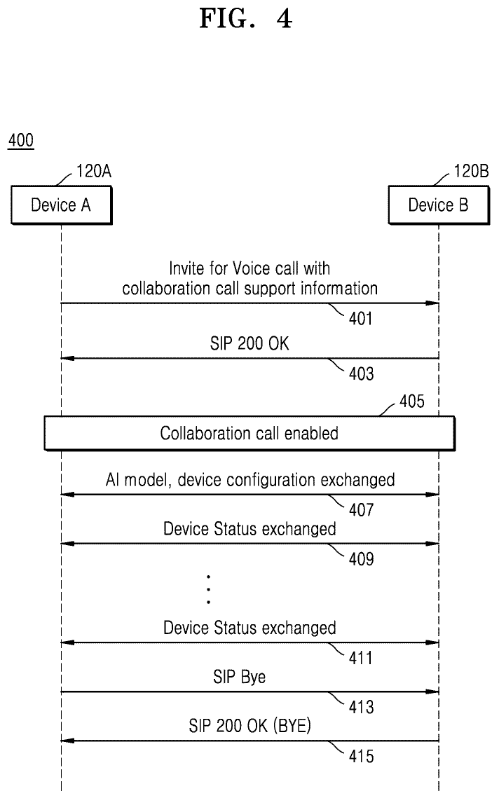

The method 300 is further explained in reference to FIGS. 4, 5A, 5B and 6 (which may be referred to as FIGS. 4 to 6). FIG. 4 is a signal flow diagram 400 illustrating an example of the exchange of device and AI model information, according to various embodiments. As shown, at operation 401, the device B (e.g., one of the candidate devices, such as 120B) may receive an incoming call invite from device A (e.g., the first device 120A). The call invite may include the “collaboration support” related information. The collaboration support related information may indicate that the device A 120A is interested in having a collaboration call with device B 120B. The collaboration support related information may be sent in one of an SIP, a Session Description Protocol (SDP) attribute, and an information line. The example of the SIP/SDP is presented below:
m=audio 60000 RTP/AVP 8
a=Collaboration_Support

If device B 120B is also in the list of trusted devices of the device A 120A, list and the device B 120B also wants to have the collaboration call, then at operation 403, the device B 120B may transmit a “Collaboration Support” accepted information in SIP 200 OK. At operation 405, the collaboration call is enabled between the device A 120A and the device B 120B. Then, the device A 120A and the device B 120B negotiate to use the “collaboration call” feature. At operation 407, the device A 120A and the device 120B exchange the device information (e.g., the first device information and the candidate device information) and the AI model information (e.g., the AI model information and the candidate AI model information). The device information and the AI model information may be exchanged via one of the SIP/SDP/RTCP SDES messages. Thereafter, the device status is exchanged between the device A 120A and the device 120B through operations 409-411. Accordingly, the device information, AI model information, and the device status can be used to enhance user call experience. In general, when the device A 120A makes a call and the device B 120 B accepts to have a call collaboration, then both the devices, e.g., device A 120A and device B can utilize the AI model capabilities of each other device to enhance user experience. However, if the device B 120B does not support any AI model (but device A 120A supports) or the device B 120B cannot run the AI model due to low capability or high sensitivity to power consumption, the AI model will instead run on Device A to maintain the user experience. Further, at operation 413, the device A 120A may terminate the call. Accordingly, the device A 120A may transmit a SIP bye message to the device B 120B. In response, at operation 415, the device B 120B may transmit an acknowledgment, e.g., SIP 200 OK to the device A 120A.

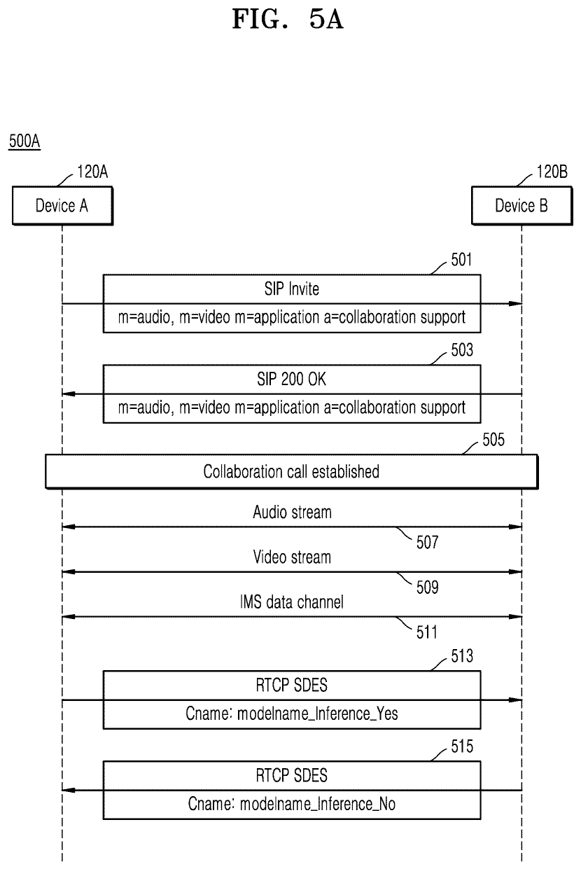

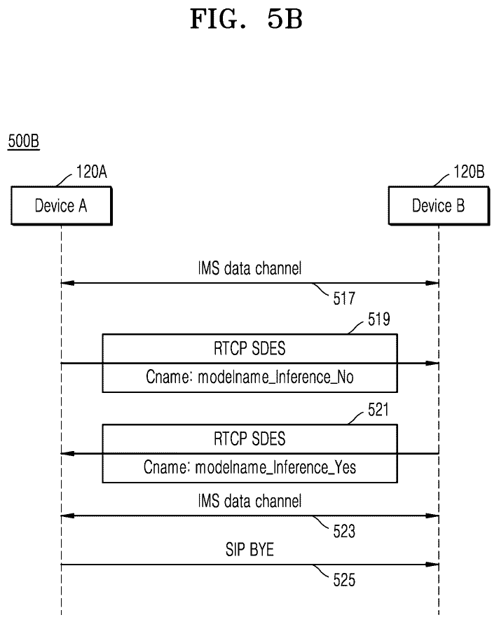

FIGS. 5A and 5B are signal flow diagrams 500A-500B illustrating an example of the selection of the candidate device, according to various embodiments. As shown in FIG. 5A, at operation 501, the device A 120A may transmit a SIP Invite to the device B 120B with Audio [m=audio], Video [m=video], and Data Channel/WebRTC [m=application]. As the device B 120B is in the list of trusted devices of the device A 120A, a new attribute, e.g., a=collaboration support is also sent in the SIP invite. The new attribute indicates that the device A 120A is interested in having a collaboration call with the device B 120B. In response, at operation 503, the device B 120B may accept the call invite. Accordingly, the device B 120B may transmit an acknowledgment e.g., SIP 200OK with collaboration support information. At operation 505, the collaboration call is established between the device A 120A and the device B 120B. Now both the devices are ready to exchange the AI model information (e.g., the AI model information and the candidate AI model information), device status (e.g., the first device status and the candidate device status), and device information (e.g., the first device information and the candidate device information) along with data, such as audio and video data. Accordingly, at operation 507, the device A 120A and the device B 120B may exchange the audio stream over the audio Real-time Transport Protocol (RTP) Port. At operation 509, the device A 120A and the device B 120B may exchange the video stream over the video RTP Port. At operation 511, the device A 120A and the device B 120B may exchange the device information, the device status, and the AI model information over an Internet Protocol (IP) Multimedia Subsystem (IMS) data channel. Then, both the device A 120A and the device B 120B may decide to run the one or more AI models in the device A 120A based on the exchanged information. Accordingly, at operation 513, the device A 120A may transmit an RTCP SDES message to convey which device will run the one or more AI models. The device A 120A may transmit the SDES message with Interface_Yes with model name information and may start running the one or more AI models. In response, at operation 515, the device B 120B may transmit an RTCP SDES message to convey which device will run the one or more AI models. The device B 120B may transmit the SDES message with Interface_No with model name information.

Further, as shown in FIG. 5B, the device A 120 A and the device B 120B may periodically exchange the AI model information, the device status, and the device information via the IMS data channel at operation 517. Then, both the device A 120A and the device B 120B may decide to run the one or more AI models in the device B 120B based on the periodically exchanged information, as the device B 120B is best suited at the current moment. Accordingly, model execution handover/offload happens from the device A 120A to the device B 120B. Accordingly, at operation 519, the device A 120A may transmit an RTCP SDES message to convey which device will run the one or more AI models. The device A 120A may send the SDES message with Interface_NO with model name information. In response, at operation 521, the device B 120B may transmit an RTCP SDES message to convey which device will run the one or more AI models. The device B 120B may transmit the SDES message with Interface_Yes with model name information and may start running the one or more AI models. Then, the device A 120 A and the device B 120B may periodically exchange the AI model information, the device status, and the device information via the IMS data channel at operation 523. Further, at operation 525, the device A 120A may terminate the call. Accordingly, the device A 120A may transmit an SIP bye message to the device B 120B.

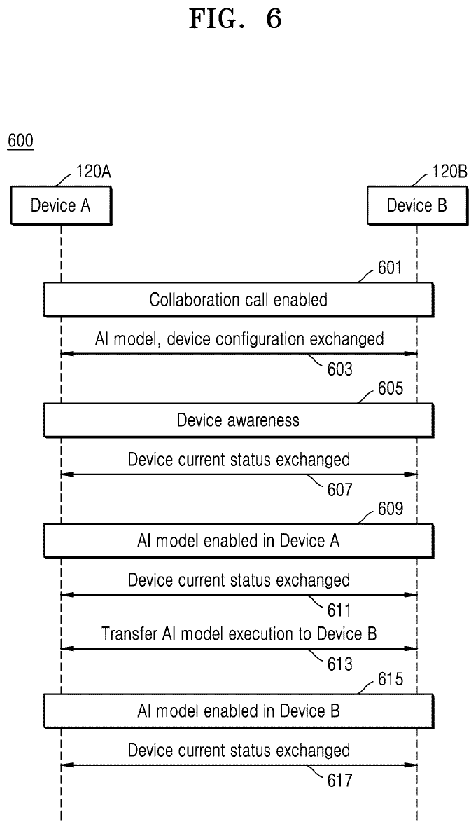

FIG. 6 is a signal flow diagram 600 illustrating an example of managing the call session between the plurality of devices 120, according to various embodiments. As shown, at operation 601, a collaboration call is established between the device A 120A and the device B 120B. At operation 603, both the devices exchange the AI model information, the device information, and the device status with each other periodically or as and when required. The said information may be exchanged using the SIP/SDP/TCP protocol. Accordingly, at operation 605, after exchanging the information, both the devices are aware of the other device's capabilities and status. To improve QOE in the call, both the devices decided to enable an AI model (such as translation or transcription or loss reduction/recovery related AI models). Accordingly, at operation 607, the device A 120A and the device B 120B exchange the corresponding device status. Then, at operation 609, based on the current device status, initially the AI model execution is started in the device A 120A. However, the battery of the device A 120A is draining faster due to the AI model execution. Accordingly, at operation 611, the device A 120A and the device B 120B exchange the corresponding device status (such as battery, RAM/CPU usage, etc.). Then, a new decision is taken to switch the AI model execution to the device B 120B as the device B 120B is currently best suited. Accordingly, the device A 120A may send a handover request to the device B 120B. Accordingly, at operation 613, the AI model execution is transferred to the device B 120B. Then, at operation 615, the AI model execution is enabled in the device B 120B. Then, at operation 617, the device A 120A and the device B 120B periodically exchange the corresponding device status, and always the best-suited device is selected for the AI model execution. Accordingly, the call session (e.g., the collaboration call) is managed between the plurality of devices 120.

In an embodiment, the signal flow diagrams explained in reference to FIGS. 4 to 6 may be performed in accordance with techniques described in reference to FIGS. 2 and 3.

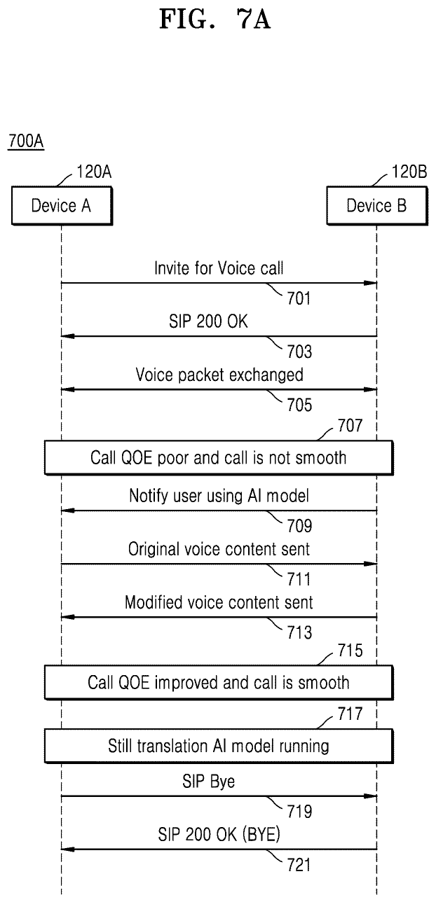

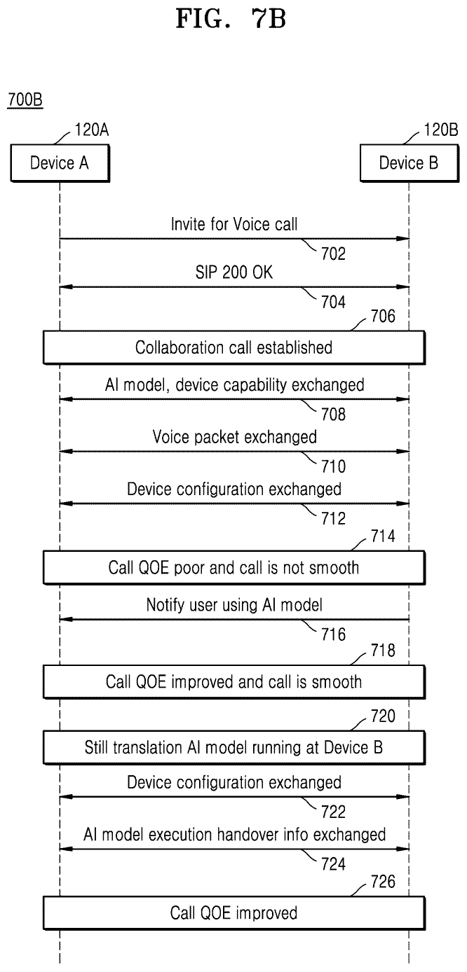

FIG. 7A is a signal flow diagram 700A depicting managing the call session between the plurality of devices 120, according to the various embodiments. FIG. 7B is a signal flow diagram 700B depicting managing the call session between the plurality of devices 120, according to various embodiments. As shown in FIG. 7A, at operation 701, the device B 120B may receive an incoming call invite from the device A 120A. In response, at operation 703, the device B 120B may transmit an acknowledgment, e.g., SIP 200 OK to the device A 120A. At operation 705, the device A 120A and the device B 120B may exchange the voice packets. At operation 707, the Quality of Experience (QOE) of the call is poor and the call is not smooth. At operation 709, the device B 120B may notify the device A 120A about the poor QOE using the AI model. Then, at operation 711, the device A 120A may transmit original voice content. In response, at operation 713, the device B 120B may transmit modified voice content. At operation 715, the QOE of the call is improved and the call is smooth. At operation 717, the AI model is still running on the device B 120B. At operation 719, the device A 120A may transmit a SIP bye message to the device B 120B to terminate the call. In response, at operation 721, the device B 120B may transmit an acknowledgment, e.g., SIP 200 OK to the device A 120A. However, as the AI model Execution happens only at the device B 120B, the battery of the device B 120B drains faster. Accordingly, the user must either manually disable the AI model execution, which impacts the QoE, or end the call prematurely to prevent or inhibit Device B (120B) from shutting down. Both scenarios negatively affect the user experience.

On the other hand, in an embodiment shown in FIG. 7B, the devices A 120A and the device B 120B collaborate during a call by periodically or once exchanging information about their AI models, device capabilities, and current statuses. If low QOE is detected, the device B 120B is initially selected to run the AI model based on the exchanged information, improving QOE. However, as the device B's battery begins to drain faster due to the AI model execution, the periodic status exchange identifies the device A 120A as the better option for running the AI model. Consequently, the AI model execution is disabled on the device B 120B and enabled on the device A 120A. For example, as shown in FIG. 7B, at operation 702, the device B 120B may receive an incoming call invite from the device A 120A. In response, at operation 704, the device B 120B may transmit an acknowledgment, e.g., SIP 200 OK to the device A 120A. At operation 706, the collaboration call is established between the device A 120A and the device B 120B. At operation 708, the device A 120A and the device B 120B may exchange the AI model information and the corresponding device capability. At operation 710, the device A 120A and the device B 120B may exchange the voice packets. At operation 712, the device A 120A and the device B 120B may exchange the corresponding device information. At operation 714, the QOE of the call is poor and the call is not smooth. At operation 716, the device B 120B may notify the device A 120A about the poor QOE using the AI model. At operation 718, the QOE of the call is improved and the call is smooth. At operation 720, the AI model is still running on the device B 120B. At operation 722, the device A 120A and the device B 120B may exchange the corresponding device information. At operation 724, the device A 120A may exchange the AI model execution handover information. The AI model execution handover information may indicate that the AI model is to be transferred from the device B 120B to the device A 120A. Accordingly, at operation 726, the QOE is improved. This dynamic adjustment allows the user to continue the call for a longer duration with improved QOE.

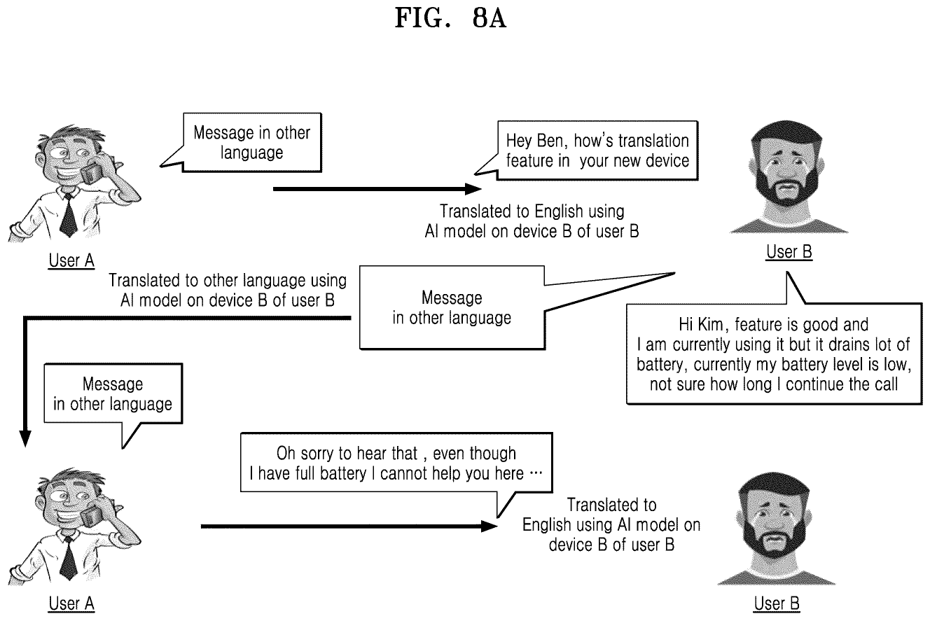

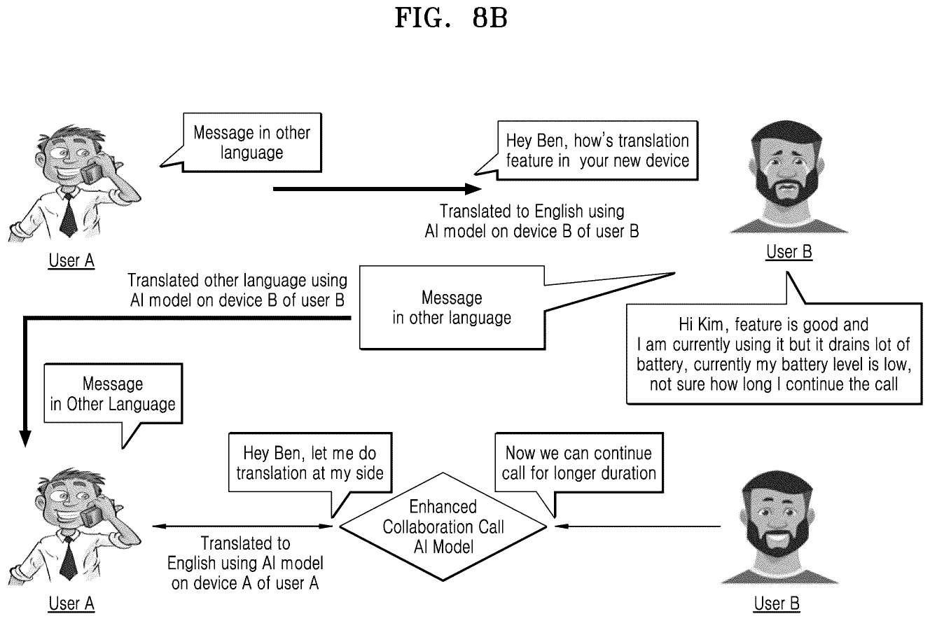

FIGS. 8A and 8B are diagrams illustrating managing the call session between the plurality of devices, according to various embodiments. As shown in FIG. 8A, both the devices (e.g., a device A with user A and a device B with user B) support the AI model, but it is currently enabled only on one side (device B). For example, messages from the user A in other language may be translated into English using the AI model executed on the device B. The battery of the device B is already low, and the AI model usage is accelerating its depletion. If the call collaboration is not supported, while the device A has more battery capacity, there is no automatic mechanism to transfer the AI model execution from the device A to the device B. On the other hand, as shown in FIG. 8B, as the battery of the device B begins to drain faster due to the AI model execution, the disclosed techniques of call collaboration identify the device A as the better option for running the AI model for translation. Consequently, the AI model execution is disabled on the device B and enabled on the device A. This dynamic adjustment allows the user to continue the call for a longer duration with improved QOE.

A method for managing a call session between a plurality of devices in accordance with the present disclosure may comprise transmitting, by an electronic device among the plurality of devices, electronic device information associated with the electronic device and Artificial Intelligence (AI) model information corresponding to one or more AI models supported by the electronic device in a call session, to one or more candidate devices among the plurality of devices. The method may comprise receiving, by the electronic device, at least one of a candidate device information associated with the one or more candidate devices or candidate AI model information corresponding to the one or more AI models, from the one or more candidate devices. The method may comprise selecting, by the electronic device, a candidate device among the one or more candidate devices for executing the one or more AI models based on at least one of the electronic device information, the candidate device information, the AI information, or the candidate AI model information. The method may comprise transmitting, by the electronic device, a command to activate the one or more AI models for execution to the selected candidate device for a predefined period.

Alternatively or additionally, the method may comprise terminating, by the electronic device, execution of the one or more AI models on the electronic device.

Alternatively or additionally, the method may comprise receiving a candidate device status associated with each of the one or more candidate devices over a predefined time interval until an end of the call session. The method may comprise determining whether to transmit the command to activate the one or more AI models to one of the one or more candidate devices other than the selected candidate device based on an electronic device status associated with the electronic device and the candidate device status.

Alternatively or additionally, prior to transmitting the electronic device information and the AI model information, the method may comprise identifying the one or more candidate devices from a list of trusted devices.

Alternatively or additionally, prior to transmitting the electronic device information and the AI model information, the method may comprise transmitting, by the electronic device, a collaboration call request to the one or more candidate devices. The method may comprise receiving, by the electronic device, candidate device capabilities associated with each of the one or more candidate devices in response to the collaboration call request. The method may comprise establishing, by the electronic device, the collaboration call with the one or more candidate devices based on the received candidate device capabilities.

Alternatively or additionally, the method may comprise transmitting the electronic device information and the AI model information periodically or in response to an information request. The method may comprise receiving the candidate AI model information and the candidate device information periodically or in response to an information request.

Alternatively or additionally, each of the AI model information and the candidate AI model information may include at least one of an AI model name, an AI model version, an input parameter, an output, an AI model layer, or architecture details corresponding to each of the one or more AI models.

Alternatively or additionally, the electronic device information may include at least one of a size of a Random Access Memory (RAM), a size of a Read Only Memory (ROM), a display size, processing information associated with at least one of a Central Processing Unit (CPU), a Graphics Processing Unit (GPU) or a Neural Processing Unit (NPU), or a battery status of the electronic device.

Alternatively or additionally, the candidate device information may include at least one of a size of a RAM, a size of a ROM, a display size, processing information associated with at least one of a CPU, a GPU or a NPU, or a battery status of the one or more candidate devices.

Alternatively or additionally, the electronic device status may include at least one of a RAM load, a CPU load, an available ROM memory, a battery status, or a drain rate of the battery of the electronic device.

Alternatively or additionally, the candidate device status may include at least one of a RAM load, a CPU load, an available ROM memory, a battery status, or a drain rate of the battery of the one or more candidate devices.

Alternatively or additionally, the method may comprise receiving the candidate device information excluding the candidate AI model information, based on the one or more AI models not being available on the one or more candidate devices. The method may comprise transmitting the one or more AI models to the one or more candidate devices. The method may comprise receiving the candidate AI model information in response to the transmitted one or more AI models.

Alternatively or additionally, the method may comprise encrypting the electronic device information and the AI model information using a predefined encryption technique. The method may comprise transmitting the encrypted electronic device information and encrypted the AI model information to the one or more candidate devices.

An electronic device configured to manage a call session between a plurality of devices in accordance with the present disclosure may comprise at least one processor comprising processing circuitry. The electronic device may comprise memory comprising one or more storage mediums storing one or more instructions. When executed by the at least one processor individually or collectively, the one or more instructions may cause the electronic device to transmit electronic device information associated with the electronic device and Artificial Intelligence (AI) model information corresponding to one or more AI models supported by the electronic device in a call session, to one or more candidate devices among the plurality of devices. When executed by the at least one processor individually or collectively, the one or more instructions may cause the electronic device to receive at least one of a candidate device information associated with the one or more candidate devices or candidate AI model information corresponding to the one or more AI models, from the one or more candidate devices. When executed by the at least one processor individually or collectively, the one or more instructions may cause the electronic device to select a candidate device among the one or more candidate devices for executing the one or more AI models based on at least one of the electronic device information, the candidate device information, the AI information, or the candidate AI model information. When executed by the at least one processor individually or collectively, the one or more instructions may cause the electronic device to transmit a command to activate the one or more AI models for execution to the selected candidate device for a predefined period.

Alternatively or additionally, when executed by the at least one processor individually or collectively, the one or more instructions may cause the electronic device to terminate execution of the one or more AI models on the electronic device.

Alternatively or additionally, when executed by the at least one processor individually or collectively, the one or more instructions may cause the electronic device to receive a candidate device status associated with each of the one or more candidate devices over a predefined time interval until an end of the call session. When executed by the at least one processor individually or collectively, the one or more instructions may cause the electronic device to determine whether to transmit the command to activate the one or more AI models to one of the one or more candidate devices other than the selected candidate device based on an electronic device status associated with the electronic device and the candidate device status.

Alternatively or additionally, when executed by the at least one processor individually or collectively, the one or more instructions may cause the electronic device to identify the one or more candidate devices from a list of trusted devices, prior to transmitting the electronic device information and the AI model information.

Alternatively or additionally, when executed by the at least one processor individually or collectively, the one or more instructions may cause the electronic device to, prior to transmitting the electronic device information and the AI model information, transmit a collaboration call request to the one or more candidate devices. When executed by the at least one processor individually or collectively, the one or more instructions may cause the electronic device to, prior to transmitting the electronic device information and the AI model information, receive candidate device capabilities associated with each of the one or more candidate devices in response to the collaboration call request. When executed by the at least one processor individually or collectively, the one or more instructions may cause the electronic device to, prior to transmitting the electronic device information and the AI model information, establish the collaboration call with the one or more candidate devices based on the received candidate device capabilities.

Alternatively or additionally, when executed by the at least one processor individually or collectively, the one or more instructions may cause the electronic device to, transmit the electronic device information and the AI model information periodically or in response to an information request. When executed by the at least one processor individually or collectively, the one or more instructions may cause the electronic device to receive the candidate AI model information and the candidate device information periodically or in response to an information request.

A non-transitory computer-readable storage medium in accordance with the present disclosure may store computer-executable instructions. When executed by at least one processor of an electronic device individually or collectively, computer-executable instructions may cause the electronic device to transmit electronic device information associated with the electronic device and Artificial Intelligence (AI) model information corresponding to one or more AI models supported by the electronic device in a call session, to one or more candidate devices among the plurality of devices. When executed by at least one processor of the electronic device individually or collectively, computer-executable instructions may cause the electronic device to receive at least one of a candidate device information associated with the one or more candidate devices or candidate AI model information corresponding to the one or more AI models, from the one or more candidate devices. When executed by at least one processor of the electronic device individually or collectively, computer-executable instructions may cause the electronic device to select a candidate device among the one or more candidate devices for executing the one or more AI models based on at least one of the electronic device information, the candidate device information, the AI information, or the candidate AI model information. When executed by at least one processor of the electronic device individually or collectively, computer-executable instructions may cause the electronic device to transmit a command to activate the one or more AI models for execution to the selected candidate device for a predefined period.

Accordingly, the present disclosure provides numerous advantages, particularly in addressing privacy concerns and optimizing resource utilization. By implementing secure methods to identify trusted devices, the present disclosure ensures that sensitive information, such as device-specific details like battery status and computational capabilities, is shared only with authenticated devices. This robust privacy framework enhances data security, creating a trusted environment for collaborative AI processing. Further, the present disclosure discloses techniques to dynamically determine the most suitable device for executing AI models based on real-time conditions. This approach optimizes energy efficiency and enhances user experience by assigning tasks to devices with higher processing capabilities, such as a high-end device equipped with dedicated neural processing units (NPUs). For instance, in a scenario where one user operates a high-performance device and another uses a lower-capability device, the disclosed techniques efficiently delegate the AI model execution to the superior device. This not only ensures faster processing but also reduces power consumption. Furthermore, the disclosed techniques evaluate multiple parameters, including GPU/NPU performance, energy efficiency, and device availability, to make optimal decisions. By promoting the execution of AI tasks on more capable devices, it supports sustainable technology use, reducing overall energy consumption. This collaborative execution model aligns with global efforts toward sustainability while maximizing and/or improving resource efficiency. Additionally, the present disclosure fosters enhanced user cooperation within families, networks, or global ecosystems by enabling seamless collaboration during times of need. Users can assist one another in managing AI workloads, resulting in a better overall experience. By combining secure information exchange, energy-efficient AI execution, and a focus on sustainability, the present disclosure delivers significant benefits for individual users and the broader global community.

While specific language has been used to describe the disclosure, any limitations arising on account of the same are not intended. As would be apparent to a person in the art, various working modifications may be made to the method in order to implement the technical concept of the disclosure as taught herein.

The drawings and the forgoing description give examples of various embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for managing a call session between a plurality of devices, the method comprising:
transmitting, by an electronic device among the plurality of devices, electronic device information associated with the electronic device and Artificial Intelligence (AI) model information corresponding to one or more AI models supported by the electronic device in a call session, to one or more candidate devices among the plurality of devices;
receiving, by the electronic device, at least one of a candidate device information associated with the one or more candidate devices or candidate AI model information corresponding to the one or more AI models, from the one or more candidate devices;
selecting, by the electronic device, a candidate device among the one or more candidate devices for executing the one or more AI models based on at least one of the electronic device information, the candidate device information, the AI information, or the candidate AI model information; and
transmitting, by the electronic device, a command to activate the one or more AI models for execution to the selected candidate device for a predefined period.

2. The method as claimed in claim 1, further comprising:
terminating, by the electronic device, execution of the one or more AI models on the electronic device.

3. The method as claimed in claim 1, further comprising:
receiving a candidate device status associated with each of the one or more candidate devices over a predefined time interval until an end of the call session; and
determining whether to transmit the command to activate the one or more AI models to one of the one or more candidate devices other than the selected candidate device based on an electronic device status associated with the electronic device and the candidate device status.

4. The method as claimed in claim 1, wherein prior to transmitting the electronic device information and the AI model information, the method comprising:
identifying the one or more candidate devices from a list of trusted devices.

5. The method as claimed in claim 1, wherein prior to transmitting the electronic device information and the AI model information, the method comprising:
transmitting, by the electronic device, a collaboration call request to the one or more candidate devices;
receiving, by the electronic device, candidate device capabilities associated with each of the one or more candidate devices in response to the collaboration call request; and
establishing, by the electronic device, the collaboration call with the one or more candidate devices based on the received candidate device capabilities.

6. The method as claimed in claim 1, wherein transmitting the electronic device information and the AI model information comprises transmitting the electronic device information and the AI model information periodically or in response to an information request, and
wherein receiving the candidate AI model information and the candidate device information comprises receiving the candidate AI model information and the candidate device information periodically or in response to an information request.

7. The method as claimed in claim 1, wherein each of the AI model information and the candidate AI model information includes at least one of an AI model name, an AI model version, an input parameter, an output, an AI model layer, or architecture details corresponding to each of the one or more AI models.

8. The method as claimed in claim 1, wherein the electronic device information includes at least one of a size of a Random Access Memory (RAM), a size of a Read Only Memory (ROM), a display size, processing information associated with at least one of a Central Processing Unit (CPU), a Graphics Processing Unit (GPU) or a Neural Processing Unit (NPU), or a battery status of the electronic device.

9. The method as claimed in claim 1, wherein the candidate device information includes at least one of a size of a RAM, a size of a ROM, a display size, processing information associated with at least one of a CPU, a GPU or a NPU, or a battery status of the one or more candidate devices.

10. The method as claimed in claim 3, wherein the electronic device status includes at least one of a RAM load, a CPU load, an available ROM memory, a battery status, or a drain rate of the battery of the electronic device.

11. The method as claimed in claim 3, wherein the candidate device status includes at least one of a RAM load, a CPU load, an available ROM memory, a battery status, or a drain rate of the battery of the one or more candidate devices.

12. The method as claimed in claim 1, wherein receiving the at least one of the candidate device information or the candidate AI model information comprises:
receiving the candidate device information excluding the candidate AI model information, based on the one or more AI models not being available on the one or more candidate devices;
transmitting the one or more AI models to the one or more candidate devices; and
receiving the candidate AI model information in response to the transmitted one or more AI models.

13. The method as claimed in claim 1, wherein transmitting the electronic device information and the AI model information to the one or more candidate devices comprises:
encrypting the electronic device information and the AI model information using a predefined encryption technique; and
transmitting the encrypted electronic device information and encrypted the AI model information to the one or more candidate devices.

14. A electronic device configured to manage a call session between a plurality of devices, the electronic device comprising:
at least one processor comprising processing circuitry, and
memory comprising one or more storage mediums storing one or more instructions,
wherein, when executed by the at least one processor individually or collectively, the one or more instructions cause the electronic device to:
transmit electronic device information associated with the electronic device and Artificial Intelligence (AI) model information corresponding to one or more AI models supported by the electronic device in a call session, to one or more candidate devices among the plurality of devices;
receive at least one of a candidate device information associated with the one or more candidate devices or candidate AI model information corresponding to the one or more AI models, from the one or more candidate devices;
select a candidate device among the one or more candidate devices for executing the one or more AI models based on at least one of the electronic device information, the candidate device information, the AI information, or the candidate AI model information; and
transmit a command to activate the one or more AI models for execution to the selected candidate device for a predefined period.

15. The electronic device as claimed in claim 14, wherein, when executed by the at least one processor individually or collectively, the one or more instructions further cause the electronic device to terminate execution of the one or more AI models on the electronic device.

16. The electronic device as claimed in claim 14, wherein, when executed by the at least one processor individually or collectively, the one or more instructions further cause the electronic device to:
receive a candidate device status associated with each of the one or more candidate devices over a predefined time interval until an end of the call session; and
determine whether to transmit the command to activate the one or more AI models to one of the one or more candidate devices other than the selected candidate device based on an electronic device status associated with the electronic device and the candidate device status.

17. The electronic device as claimed in claim 14, wherein, when executed by the at least one of more processor individually or collectively, the one or more instructions further cause the electronic device to identify the one or more candidate devices from a list of trusted devices, prior to transmitting the electronic device information and the AI model information.

18. The electronic device as claimed in claim 14, wherein prior to transmitting the electronic device information and the AI model information, when executed by the at least one of more processor individually or collectively, the one or more instructions further cause the electronic device to:
transmit a collaboration call request to the one or more candidate devices;
receive candidate device capabilities associated with each of the one or more candidate devices in response to the collaboration call request; and
establish the collaboration call with the one or more candidate devices based on the received candidate device capabilities.

19. The system as claimed in claim 14, wherein, when executed by the at least one processor individually or collectively, the one or more instructions further cause the electronic device to:
transmit the electronic device information and the AI model information periodically or in response to an information request; and
receive the candidate AI model information and the candidate device information periodically or in response to an information request.

20. A non-transitory computer-readable storage medium storing computer-executable instructions that, when executed by at least one processor of an electronic device individually or collectively, cause the electronic device to:
transmit electronic device information associated with the electronic device and Artificial Intelligence (AI) model information corresponding to one or more AI models supported by the electronic device in a call session, to one or more candidate devices among the plurality of devices;
receive at least one of a candidate device information associated with the one or more candidate devices or candidate AI model information corresponding to the one or more AI models, from the one or more candidate devices;
select a candidate device among the one or more candidate devices for executing the one or more AI models based on at least one of the electronic device information, the candidate device information, the AI information, or the candidate AI model information; and
transmit a command to activate the one or more AI models for execution to the selected candidate device for a predefined period.
